(19) United States
(12) Patent Application Publication
(10) Pub. No.: US 2013/0228498 A1
(43) Pub. Date: Sep. 5, 2013

(54) METHOD FOR DETECTION OF CONTAMINATED OBJECTS

(71) Applicant: Arturo Agüero, San José (CR)

(72) Inventor: Arturo Agüero, San José (CR)

(73) Assignee: Xeltron, S.A., San José (CR)

(21) Appl. No.: 13/635,431

(22) PCT Filed: Mar. 17, 2011
(86) PCT No.: PCT/IB2011/000688

§ 371 Date: Nov. 28, 2012

Related U.S. Application Data
(60) Provisional application No. 61/314,852, filed on Mar. 17, 2010.

(51) Int. Cl. B07C 5/342; G01N 21/64

(52) U.S. Cl. CPC B07C 5/342; G01N 21/64
USPC 209/3.1; 250/453.11

(57) ABSTRACT

The present invention relates generally to a method for optical sorting and more particularly, but not by way of limitation, to an apparatus and method for sorting individual objects such as, for example, beans, grains, fruit and the like such that contaminated objects can be separated from non-contaminated objects. The objects are pre-stimulated with a source emitting UV light and are sorted based on the signal emitted by the objects, in particular for sorting Fungus-contaminated objects.

### CROSS-REFERENCES TO RELATED APPLICATIONS

This Application claims priority from U.S. Provisional Patent Application No. 61/314,852 filed Mar. 17, 2010, which is hereby incorporated by reference as if fully set forth herein.

### BACKGROUND OF THE INVENTION

1. Technical Field

The present invention relates generally to a method for optical sorting and more particularly, but not by way of limitation, to an apparatus and method for sorting individual objects such as, for example, beans, grains, fruit and the like such that contaminated objects can be separated from non-contaminated objects. Examples include sorting objects contaminated with fungus from non-contaminated objects.

2. History of Related Art

Objects such as, for example, beans, grains, fruits and similar small-sized objects have been generally sorted using optical sorting apparatus. The objects pass through the apparatus where they are irradiated by, for example, visible light. A detector generates an electric signal derived from light reflected from the object. If the sorting is based either in whole or in part on the color of the object, then at least two detectors produce electrical signals related to light reflected from the object and detected by the detectors. Electronic circuitry processes the signals from the detectors and determines if the object should be accepted or rejected.

Many prior art sorting systems reject objects based upon color alone. Specifically, nominally identical light signals are directed to photo detectors whose response characteristics peak in different areas of the light spectrum. Thus, the output signal from each detector indicates the reflectance of the object at wavelengths at which the detectors peak. The various outputs are compared and, based upon a reference value, a decision whether to accept or reject the object is made. For example, if the object had an unacceptable color, the reflectance of the object at a certain wavelength would be below the reference value. The apparatus would then output a signal to a rejecting mechanism to have the particular object rejected.

A problem with a sorting apparatus based on color is that phenol-contaminated objects caused by the presence of fungi on an object surface are difficult to detect using the optical sorting apparatus (utilizing visible light) as discussed above. This is because fungus-contaminated objects do not show a difference in physical characteristics on the basis of color. Thus, a fungus-contaminated object that should be rejected passes undetected through the sorting apparatus that utilizes visible light.

Therefore, there is a need for a method that has the ability to sort fungus-contaminated objects from non-contaminated objects.

### SUMMARY OF THE INVENTION

An embodiment of the invention provides a method of sorting objects falling through an optical sorting apparatus, the method comprising the steps of; feeding the objects into a roller system; moving the objects on the roller system; pre-stimulating the objects on the roller system with UV light; passing the pre-stimulated objects through an optical system; analyzing the light signal emitted by the objects within the optical system; and classifying the objects on the basis of the signal emitted by the objects.

An embodiment of the invention provides an apparatus for sorting objects, the apparatus comprising a feeder, a roller system, a pre-stimulating UV source, and an optical system comprising a plurality of UV lights and an optical analyzer.

### BRIEF DESCRIPTION OF THE DRAWINGS

A more complete understanding of the apparatus and method of the present invention may be obtained by reference to the following Detailed Description when taken in conjunction with the accompanying Drawings wherein:

FIG. 1 illustrates an isometric side view of a sorting apparatus in accordance with an exemplary embodiment;

FIG. 2 is an enlarged isometric view of an optical system used with the sorting apparatus of FIG. 1;

FIG. 3 is an enlarged isometric view of an optical analyzer used with the sorting apparatus of FIG. 1;

FIG. 4 is an enlarged, cross-sectional side view of the optical analyzer taken substantially along line 4-4 of FIG. 3; and

FIG. 5 is a schematic diagram of a system in accordance with an exemplary embodiment.

### DETAILED DESCRIPTION OF ILLUSTRATIVE EMBODIMENTS OF THE INVENTION

An embodiment of the invention permits the sorting of diverse objects or granular particles by exposing them to ultraviolet (UV) radiation, with the intention of separating those objects which, due to their chemical or physical characteristics, have an altered emission profile when exposed to UV radiation.

An embodiment of the invention separates defective or contaminated objects contained in a given sample by a monochromatic colorimetric analysis system.

As used herein, the term “object” or “objects” is used to refer to grains, beans, fruit or any other product that can be sorted with the equipment disclosed herein.

As used herein, the term “monochromatic UV” means that it is possible to apply two criteria simultaneously to reject or accept a grain or object, either because it does or does not have an altered emission profile in the presence of UV light. Discrimination parameters are set by the operator according to the required selection of each product. Thus, objects can be rejected within a wide range of settings with an accuracy of up to one hundredth of the equipment's range of selectivity.

An embodiment of the invention comprises an optical system having an optical analyzer and a UV illumination system. The combination of the optical analyzer and the UV illumination system illuminates and visualizes the objects to be sorted from all angles, inspecting their total surface and classifies them according the criteria established by the user.

An advantage provided by certain embodiments of the invention is that the equipment does not require a background reference for its operation.

The operation of the equipment can be divided into four steps namely, the feed step, the UV pre-stimulation step, the optical analysis step, and the classification step.

Embodiment(s) of the invention will now be described more fully with reference to the accompanying Drawings. The invention may, however, be embodied in many different forms and should not be construed as limited to the embodiment(s) set forth herein.

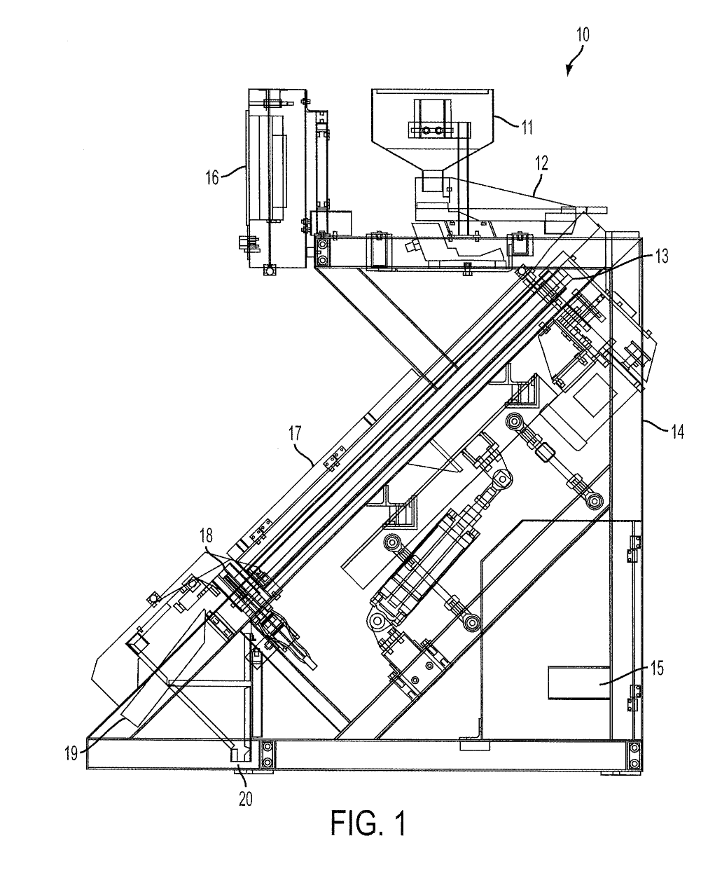

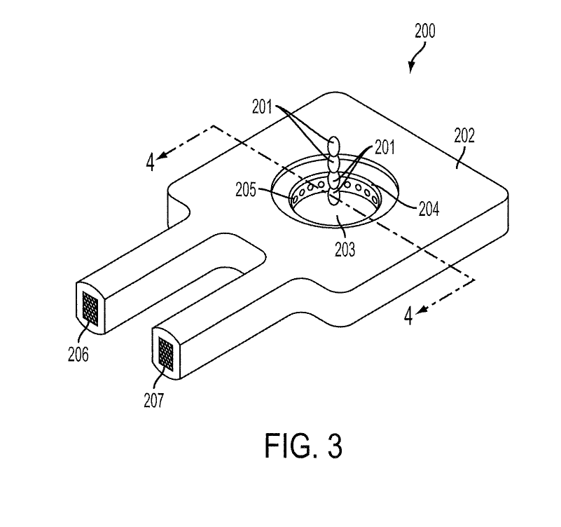

An optical sorting apparatus 10 incorporating the present invention is shown in FIG. 1. The apparatus 10 is illustrated as having a channel, having a feeder bin 11 in which objects to be sorted are loaded. In a typical embodiment, the objects may be, for example, beans, grains, fruit and the like. The objects pass from the feeder bin 11 in a controlled fashion to provide a continuous flow and a uniform distribution of objects. The objects, indicated by reference numeral 201 in FIG. 3, are released separately and fall one-by-one, under the influence of gravity, through a central opening 203 in the center of an analysis head 202, as best shown in FIG. 3. UV light illuminates the objects as they pass through the opening 203 by a plurality of lamps (not explicitly shown).

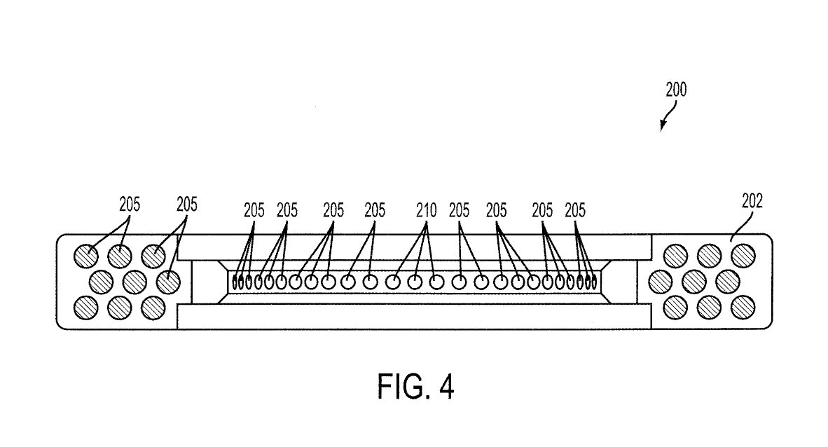

The UV light causes certain of the objects to emit fluorescence. The fluorescent light that is emitted by the surface of the objects 201 and onto a plurality of optical fibers 205 arranged with one of their ends spaced-apart in a row around the opening 203 of the analysis head 202. As shown in FIG. 3, the optical fibers 205 are bundled into two bundles 206 and 207. The optical fibers are preferably cast in a plastic head unit. A ring 204 as set forth in FIG. 4, preferably of aluminum, receives the end of the optical fibers 205 arranged about the opening 203, the ring 204 secured to the head unit 202 about the opening 203.

A signal analyzer (not explicitly shown) for the apparatus 10 receives the other ends of the optical fibers 205 and thus the fluorescence light transmitted or conducted through these fibers. In an embodiment of the invention, the optical fibers 205 transmit the fluorescence light to photocells 210, where it is converted into electrical signals. Those having ordinary skill in the art will appreciate that the optical fibers transmit light reflected from the object 201 as it passes through the opening 203 of the analysis head 202, and that any means of transmitting light from the analysis head to the signal analyzer may be used. The signal analyzer is housed in a control unit (not explicitly shown) having a control panel (not explicitly shown) which displays information and allows the operator to control the apparatus 10, including the setting of various reference values discussed below.

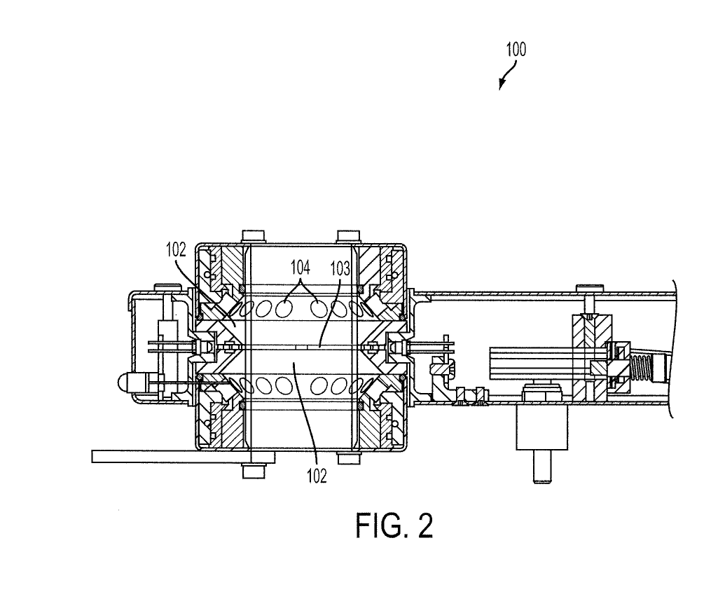

The analysis head 202 is part of the optical system 18 of the apparatus 10. The optical system 18 (100 in FIG. 2) further comprises two lighting rings 102 as set forth in FIG. 2 that are located above and below the analysis head 202. The analysis head 202, while not explicitly shown in FIG. 2 is generally located at position 103 in FIG. 2. The lighting rings 102 comprise a plurality of UV light emitting diodes 104. In a typical embodiment, the UV light emitting diodes 104 are operable to illuminate the objects 201 with the purpose of exciting the surface of the objects 201. In a typical embodiment, the objects 201 due to their chemical characteristics tend to fluoresce. Examples of such chemical characteristics include the presence of fungal contamination or phenol contamination on the surface of the objects 201. The lighting rings 102 sandwich the analysis head 202 between the two rings in a manner as to create an opening (203 in FIG. 3) to allow the passage of the objects 201. As the objects 201 pass through the opening 203, they are illuminated by the UV light emitting diodes 104.

The objects 201 that are not excited by the UV emissions from the UV light emitting diodes 104 are separated from the ones that are excited by the UV emissions. In a typical embodiment, the optical analyzer is operable to capture individual fluorescence level reading of each object 201. The apparatus 10 is operable to sort objects 201 based upon their fluorescent level readings. As such, phenol-contaminated objects and fungus-contaminated objects are separated from non-contaminated objects utilizing the apparatus 10 disclosed herein. For example, the objects 201 showing higher or lower than average fluorescent level readings are considered contaminated and are separated.

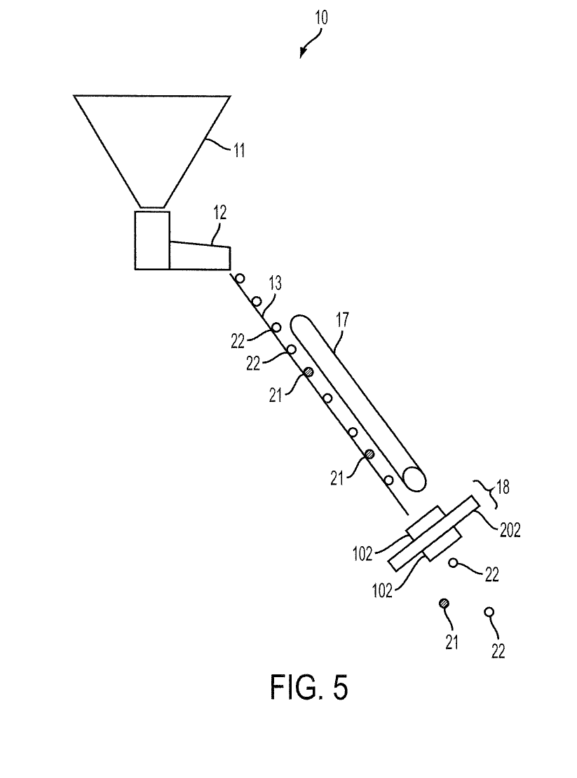

FIG. 5 is a block diagram of an optical sorter in accordance with an exemplary embodiment. The numbers used to designate the various parts of the sorter are the same as those used in FIGS. 1-4 for the sake of consistency. The sorter 10 is utilized for separating contaminated objects 21 from non-contaminated objects 22. The objects 21 and 22 pass from the feeder bin 11 in a controlled fashion to provide a continuous flow and a uniform distribution of objects. The objects, 21 and 22, are released separately and fall one-by-one, under the influence of gravity, through a central opening in the center of an optical system 18. UV light illuminates the objects as they pass through the opening by a plurality of lamps (not explicitly shown) in the optical system 18.

An embodiment of the invention provides a method of sorting objects falling through an optical sorting apparatus, the method comprising the steps of; feeding the objects into a roller system; moving the objects on the roller system; pre-stimulating the objects on the roller system with UV light; passing the pre-stimulated objects through an optical system; analyzing the light signal emitted by the objects within the optical system; and classifying the objects on the basis of the signal emitted by the objects.

As set forth in FIG. 5, in the feed step, the product to be sorted moves from a large feeder bin 11 to a feeder 12 that is inserted in the equipment. Thereafter, an electric vibration system feeds the machine and the product is evenly distributed to an alignment system by means of a roller system 13 wherein the objects 21 and 22 slide into the optical system 18. The objects 21 and 22 move at a rate of around 3.5 to 4 m/s along the roller system. Furthermore, the rollers contained within the roller system 13 are located at an angle of 45° C. relative to the feeder.

As they pass along the roller system 13, the objects 21 and 22 to be sorted are exposed to an ultraviolet light source 17 having an output ranging from 365 to 375 nm. The UV light source 17 pre-stimulates the fungus-contaminated objects thereby causing these contaminated objects to fluoresce. This pre-stimulation step takes about 1/250^{th} of a second (i.e., 4 milliseconds), which is sufficient time to excite the surface of the contaminated objects while they are on the roller system 13, thereby causing these objects to fluoresce. The pre-stimulation step allows for an improved selection process whereby the contamination objects can be separated from the non-contaminated objects.

The main components of the optical analysis system 18 are two lighting rings and the optical analyzer (shown in greater detail in FIGS. 2 and 3). The lighting rings 102 are installed above and below the optical analyzer 202. A set of UV light-emitting diodes 104 (“LEDs”) with a very specific light emission range (365 to 375 nm) are circumferentially located on the lighting rings 102 and illuminate the entire surface of the object to be sorted. A group of optical fibers (205 in FIG. 4) receive the light reflected by the objects 21 and 22 and transmit it to photocells (210 in FIG. 4) where it is converted into electrical signals. These signals are analyzed by a computerized electronic system or CPU (not explicitly shown) that decides whether the objects are good or should be rejected, according to the user's criteria.

In the optical analysis step, the light of the grain captured in the photocell 210 is sent to a computer to be analyzed. Each object that passes through the analyzer creates an exclusive signal. These signals are the ones that permit the rejection of the objects based on the established parameters. If the object is within the acceptance criteria, it continues along the trajectory and is collected in the accepted product output bin (19 in FIG. 1). If the object is rejected, it is collected in the rejected product output bin (20 in FIG. 1).

In the classification step, a controlled flow of compressed air from an air control system 15 rejects the objects that are out of the established parameters, which triggers just when the object passes in front of the air ejection nozzle of the reject valve. The air control system contains an air inlet 14 wherein the air enters the compressor. The compressed air system generates an airflow having a pressure of 6 to 8 bars (100 to 120 Psi).

The parameters that are typically used in embodiments of the invention include without limitation, the rejection of objects displaying any fluorescence/ signal in the visible spectrum, i.e., 390 nm to 750 nm, in response to illumination by UV light.

The machine is operated and supervised by a user interface (16 in FIG. 1), which displays and manipulates all operating parameters of the equipment through high-resolution charts. It shows in addition all information regarding the product sorting process, such as production and percentage of defects being removed.

The optical sorter is installed in a dust-free environment, at a temperature between 0° C. and 35° C., with adequate ventilation. The installation of a forced ventilation system that is able to change the air of the electronics room at least once every 5 minutes or more often is recommended for optimal operation of the apparatus.

The compressed air from the air control system 15 is free of any contamination, especially water and oil, as these components affect the quality of selection and shorten the life of the optical elements.

The air supply must be free of any contamination. Contaminated air with water or oil affects the sorting quality and reduces the useful life of optical components.

What is claimed is:

1. A method of sorting objects falling through an optical sorting apparatus, the method comprising the steps of;
feeding the objects into a roller system;
moving the objects on the roller system;
pre-stimulating the objects on the roller system with UV light;
passing the pre-stimulated objects through an optical system;
analyzing the light signal emitted by the objects within the optical system; and
classifying the objects on the basis of the signal emitted by the objects.

2. The method of claim 1 further comprising the step of providing a plurality of UV lights in the optical system.

3. The method of claim 2 wherein, the plurality of UV lights illuminate the surface of the objects.

4. The method of claim 1 wherein, the UV light source in the pre-stimulating step emits light having a wavelength in the range of 365 nm to 375 nm.

5. The method of claim 2 wherein, the plurality of UV lights emit light having a wavelength of 365 nm to 375 nm.

6. The method of claim 1 wherein, the one or more objects are moved on the roller system at a rate of 3.5 to 4 m/s.

7. The method of claim 1 wherein, in the classifying step, the objects emitting a signal in the visible spectrum are separated from the objects that do not emit a signal in the visible spectrum.

8. The method of claim 1 wherein, the pre-stimulation step is carried out for a period of 1/250^{th} of a second.

9. The method of claim 1 wherein, in the analyzing step, the optical signal emitted by the objects is captured by optical fibers and carried to photocells.

10. The method of claim 9, wherein the optical signal is converted by the photocell to an electric signal.

11. An apparatus for sorting objects, the apparatus comprising
a feeder;
a roller system;
a pre-stimulating UV source; and
an optical system comprising a plurality of UV lights and an optical analyzer.

12. The apparatus of claim 11 further comprising an electric vibration system.

13. The apparatus of claim 11 wherein the plurality of lights are located on two lighting rings.

14. The apparatus of claim 13 wherein, the lighting rings are located above and below the optical analyzer.

15. The apparatus of claim 11 wherein, the optical analyzer comprises a plurality of optical fibers.

16. The apparatus of claim 11 wherein, the optical analyzer comprises a plurality of photo cells.
